(19) United States
(12) Patent Application Publication
(10) Pub. No.: US 2017/0298968 A1
(43) Pub. Date: Oct. 19, 2017

(54) MOUNTING APPARATUS

(71) Applicant: HB Solar Canada Inc., Concord (CA)

(72) Inventors: Eric Stephenson, Thornhill (CA); Derek Wilson, Toronto (CA)

(21) Appl. No.: 15/360,386

(22) Filed: Nov. 23, 2016

Related U.S. Application Data
(60) Provisional application No. 62/322,417, filed on Apr. 14, 2016.

(51) Int. Cl. F16B 2/12; F16M 13/02; F24J 2/52; H02S 20/00

(52) U.S. Cl. CPC F16B 2/12; H02S 20/00; F16M 13/022; F24J 2/5243

(57) ABSTRACT

The apparatus is for use with a concrete block and comprises a plurality of metal components. At least one of the components defines a lug. The plurality of metal components are coupled together in gripping relation to the block in use.

### RELATED APPLICATIONS

This application is a non-provisional application that claims priority benefit to U.S. Provisional Application Ser. No. 62/322,417 filed Apr. 14, 2016; the contents of which are hereby incorporated by reference.

### FIELD OF THE INVENTION

The invention relates to the field of solar energy.

### BACKGROUND OF THE INVENTION

It is known to mount solar collectors to a roof through the use of massive ballast structures that are provided with integral fasteners.

### SUMMARY OF THE INVENTION

Forming one aspect of the invention is apparatus for use with a concrete block.

The concrete block is of the type having a pair of face shells and a plurality of side walls extending between the face shells.

The plurality of side walls includes a pair of end shells.

Each side wall has a first side surface and a second side surface opposed to the first side surface.

The face shells and the side walls collectively define a pair of planar surfaces and one or more cores, each of said one or more cores extending through the block between the pair of planar surfaces.

The apparatus comprises a pair of hooks, a mechanism and a lug.

Regarding the hooks:
one of the pair of hooks is associated, in use, with one of the planar surfaces and one of the first side surfaces;
the other of the pair of hooks is associated, in use, with the other of the planar surfaces and one of the second side surfaces; and
the pair of hooks has a locked configuration wherein the one of the pair of hooks is disposed in abutting relation with the one of the planar surfaces and the one of the first side surfaces and the other of the pair of hooks is disposed in abutting relation with the other of the planar surfaces and the one of the second side surfaces.

The mechanism is adapted to selectively lock the pair of hooks in the locked configuration.

The lug is operatively connected to one or more of the pair of the hooks and the mechanism.

According to another aspect of the invention, the one of the first side surfaces and the one of the second side surfaces can form part of the same side wall.

According to another aspect of the invention, each hook can have a finger for each core.

According to another aspect of the invention, the mechanism can be adapted to permit the hooks to be completely separated from one another.

According to another aspect of the invention, the mechanism can be adapted to selectively lock the hooks together throughout a range of positions.

According to another aspect of the invention, the mechanism can comprise: a nut and bolt assembly; and for each of the pair of hooks, a part formed integrally therewith, the parts being adapted to be secured together by the nut and bolt assembly.

According to other aspect of the invention: the parts can be formed integrally with the hooks by extrusion; one of the parts can have a slot defined therewith adapted to capture the head of the bolt; and the other of the parts can have an aperture defined therethrough to permit throughpassage of the threaded shaft of the bolt, the aperture being smaller in dimension than the nut to permit the nut and the bolt head to draw the parts together.

Forming yet another aspect of the invention is apparatus for use with a concrete block. This apparatus comprises: a plurality of metal components, at least one of the components defining a lug; and at least one threaded connector. In use, the at least one threaded connecter connects the plurality of metal components together in gripping relation to the block.

Advantages and characteristics of the invention will become evident upon review of the following detailed description with reference to the appended drawings, the latter being briefly described hereinafter.

### BRIEF DESCRIPTION OF THE DRAWINGS

FIG. 1 is a perspective view of apparatus according to an exemplary embodiment of the invention

FIG. 2 is an exploded view of the structure of FIG. 1;

FIG. 3 is a profile view of the structure of encircled area 3 of FIG. 2

FIG. 4 is a profile view of the structure of encircled area 4 of FIG. 2

FIG. 5 is a perspective view of a prior art concrete block; and

FIG. 6A is a view of the structure of FIG. 1 in use with the structure of FIG. 5;

FIG. 6B is a view of the structure of FIG. 6A from another vantage point;

FIG. 6C is a view of the structure of FIG. 6A from another vantage point;

FIG. 7 is a view of another embodiment of the structure of FIG. 3;

FIG. 8A is a profile view of another embodiment of the structure of FIG. 3;

FIG. 8B is a perspective view of the structure of FIG. 8A;

FIG. 9A is a profile view of another embodiment of the structure of FIG. 4;

FIG. 9B is a perspective view of the structure of FIG. 9A;

FIG. 10 is a view of the components of a further alternative embodiment of the invention;

FIG. 11 is a perspective view of the structure in encircled area 11 of FIG. 10;

FIG. 12 is a view of the structure of FIG. 10 assembled for use;

FIG. 13 is a view of the structure of FIG. 12 in use;

FIG. 14A is a view of an alternative embodiment of the structure of FIG. 11; and

FIG. 14B is a profile view of the structure of FIG.14A.

### DETAILED DESCRIPTION OF THE INVENTION

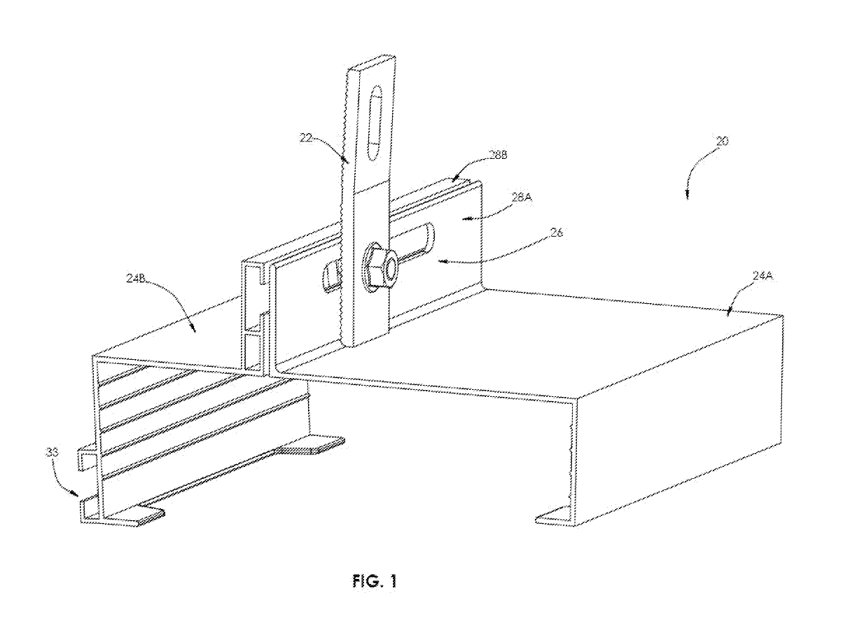

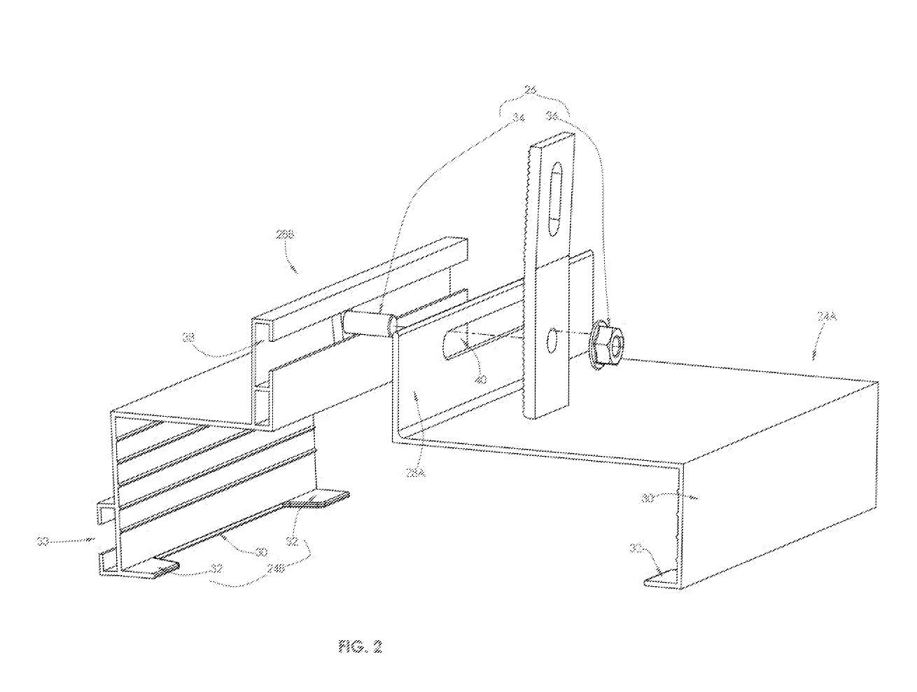

Apparatus 20 according to an exemplary embodiment of the invention is shown in FIGS. 1-6C and will be seen to include a foot 22, a pair of hooks 24A, 24B, a nut and bolt assembly 26 and a pair of parts 28A, 28B.

The foot 22 is a ribbed metal bar having a pair of apertures formed therein.

Each hook 24A, 24B will be seen to include an angle 30 and a pair of fingers 32. Hook 24B has a channel 33 formed therein.

The nut and bolt assembly 26 will be seen to include a T-bolt 34 and a nut 36.

Parts 28A, 28B will be seen to be provided one for each of the hooks 24A, 24B and formed integrally therewith, thereby defining extrusions 29B, 29A. One of the parts 28B has a slot 38 defined therewith adapted to capture the head of the T-bolt 34 against rotation but permit sliding movement. The other of the parts 28A has an aperture 40 defined therethrough to permit throughpassage of the threaded shaft of bolt 34, the aperture being smaller in dimension than nut 36 to permit nut 36 and the head of bolt 40 to draw the parts 28A,28B together, along with the foot 22, all as shown in FIG. 1.

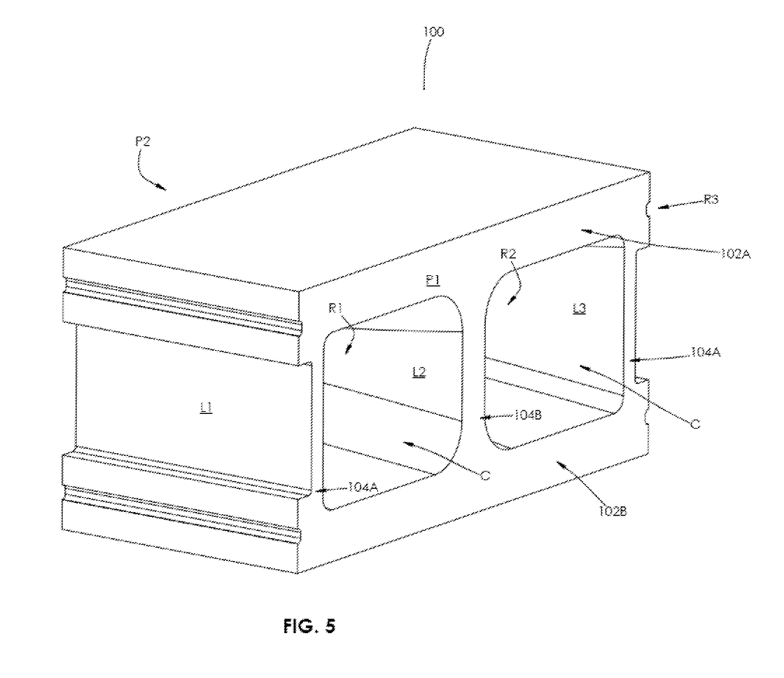

The exemplary apparatus 20 is used with the block 100 shown in FIG. 5.

The block 100, which forms no part of the present invention, will be seen to be of the type having a pair of face shells 102A, 102B and a plurality of side walls 104A, 104B extending between the face shells 102A, 102B, the plurality of side walls including a pair of end shells 104A, each side wall having a first side surface L1, L2 and L3 and a second side surface R1, R2, R3 opposed to the first side surface, the face shells and the side walls collectively defining a pair of planar surfaces P1, P2 and one or more cores C, each of said one or more cores C extending through the block between the pair of planar surfaces P1,P2.

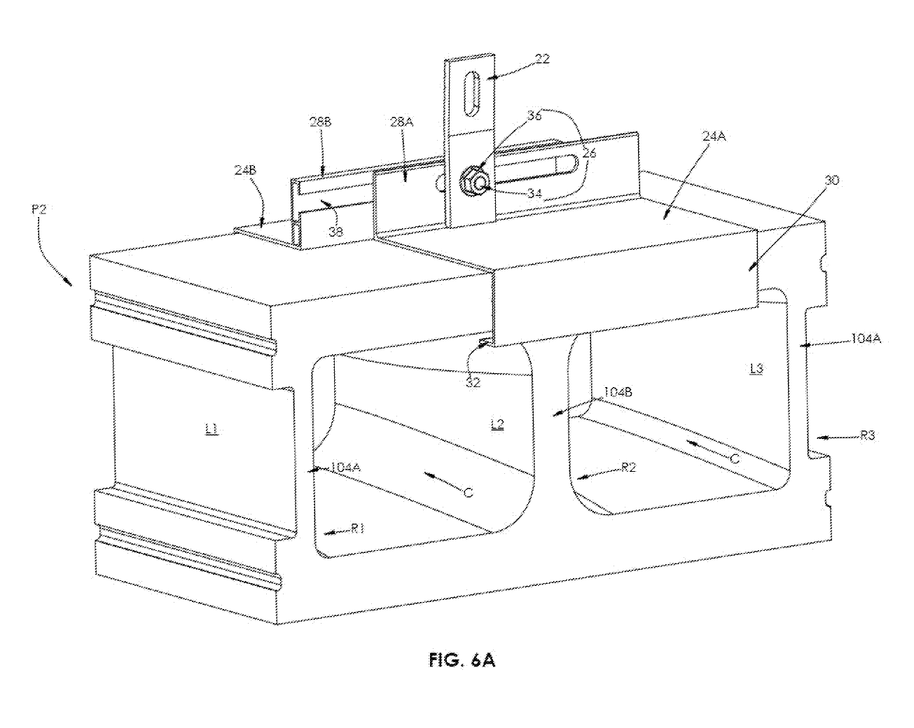

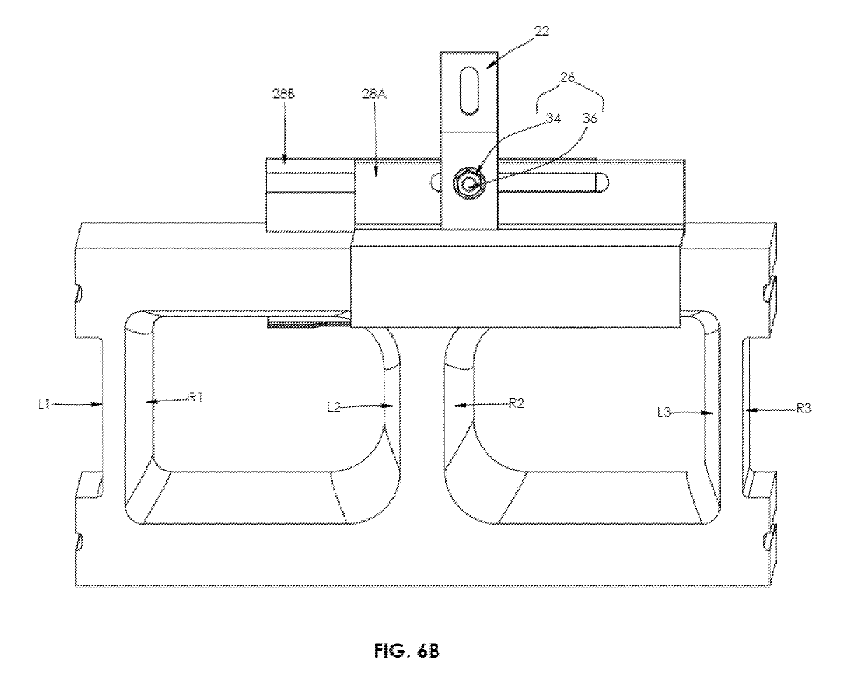

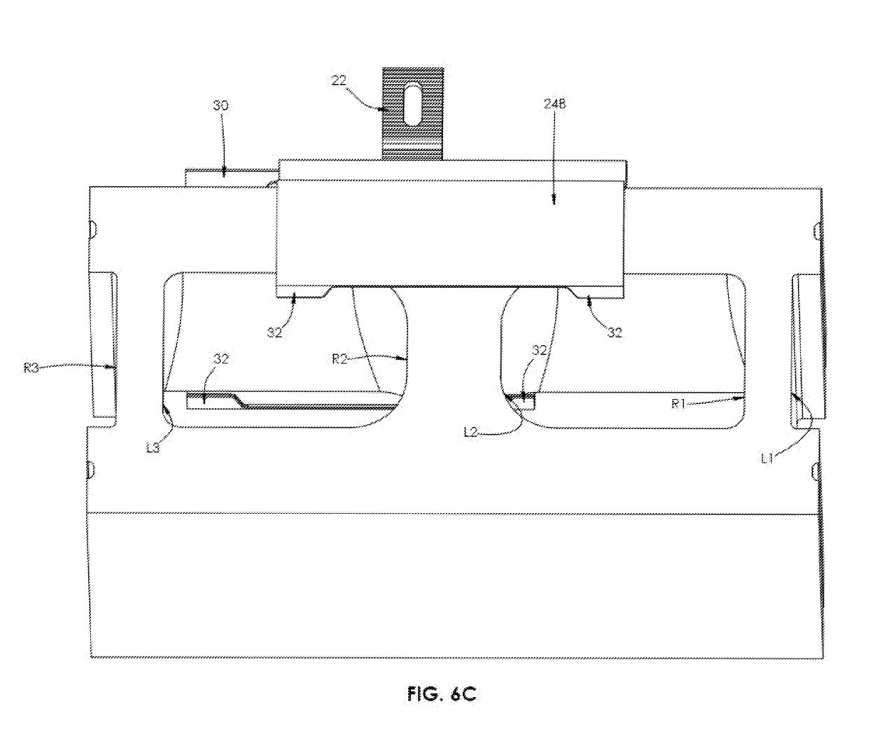

The manner of use is shown in FIG. 6A through FIG. 6C.

In this regard, it will be understood that:
one 24A of the pair of hooks is associated, in use, with one P1 of the planar surfaces and one L2 of the first side surfaces
the other 24B of the pair of hooks is associated, in use, with the other P2 of the planar surfaces and one R2 of the second side surfaces
the pair of hooks 24A, 24B has a locked configuration, as shown in FIG. 6A-C, wherein the one 24A of the pair of hooks is disposed in abutting relation with the one P1 of the planar surfaces and the one L2 of the first side surfaces and the other 24B of the pair of hooks is disposed in abutting relation with the other P2 of the planar surfaces and the one R2 of the second side surfaces
the pair of parts 28A,28B and the nut and bolt assembly 26 collectively define a mechanism and a lug
the mechanism is adapted to selectively lock the pair of hooks 24A, 24B in the locked configuration
the lug is operatively connected to one or more of the hooks and the mechanism and allows, for example, solar panels to be mounted to the block, by, for example, the foot 22
the channel 32 can be used, for example, to secure other feet (not shown)

It should be understood that the side surfaces are not all planar, and finger 32 of hook 24B is indeed engaged with R2 when shown in FIG. 6C.

Persons of ordinary skill in the art will readily appreciate the advantage associated with this structure:
relatively unskilled labor can be used for assembly
concrete block can be sourced locally
the products can be repeatedly reused and are relatively inexpensive and durable

Thus, viewed broadly, the invention can be seen to be apparatus for use with a concrete block, the apparatus comprising: a plurality of metal components, at least one of the components defining a lug; and at least one threaded connector, the at least one threaded connecter connecting the plurality of metal components together in gripping relation to the block in use.

Variations are possible.

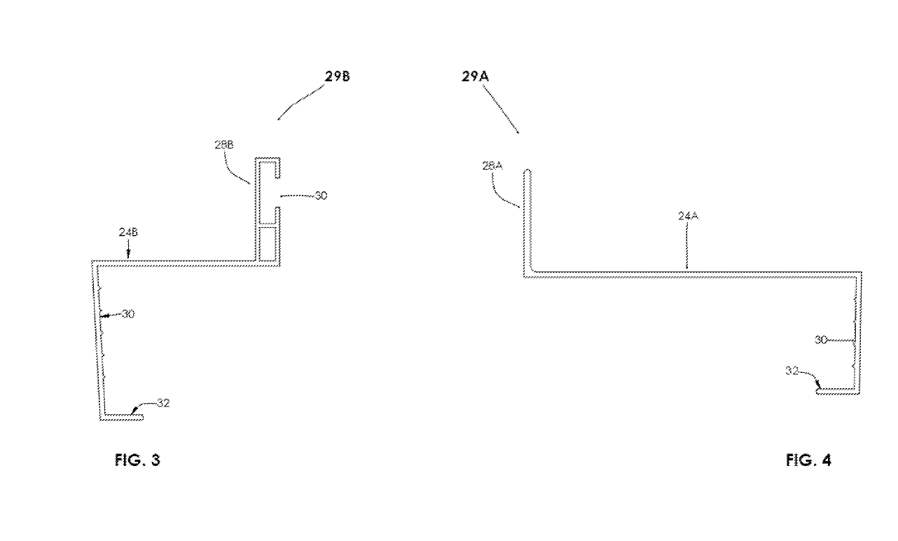

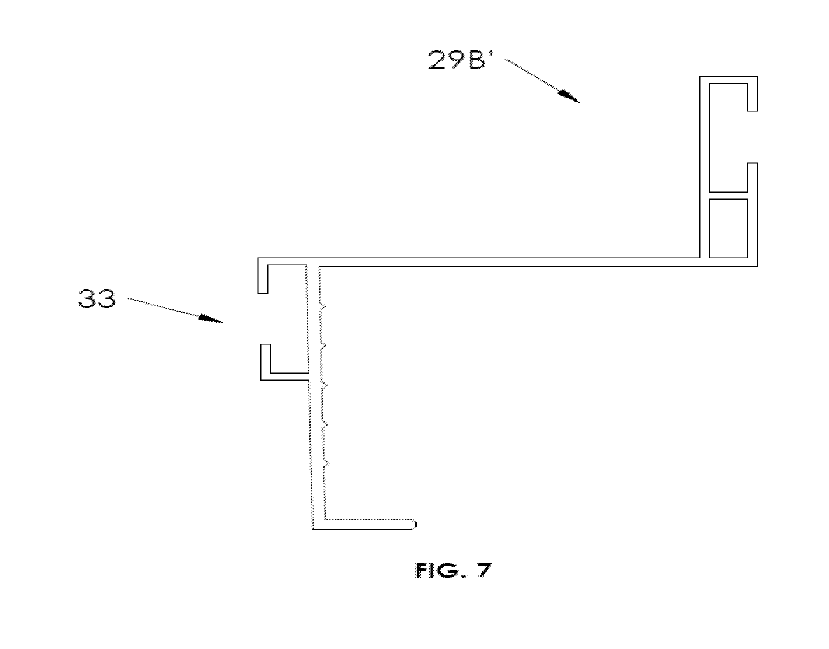

For example, FIG. 7 shows a variation 29B′ of the structure of FIG. 3 wherein the channel 33 is formed at a different location.

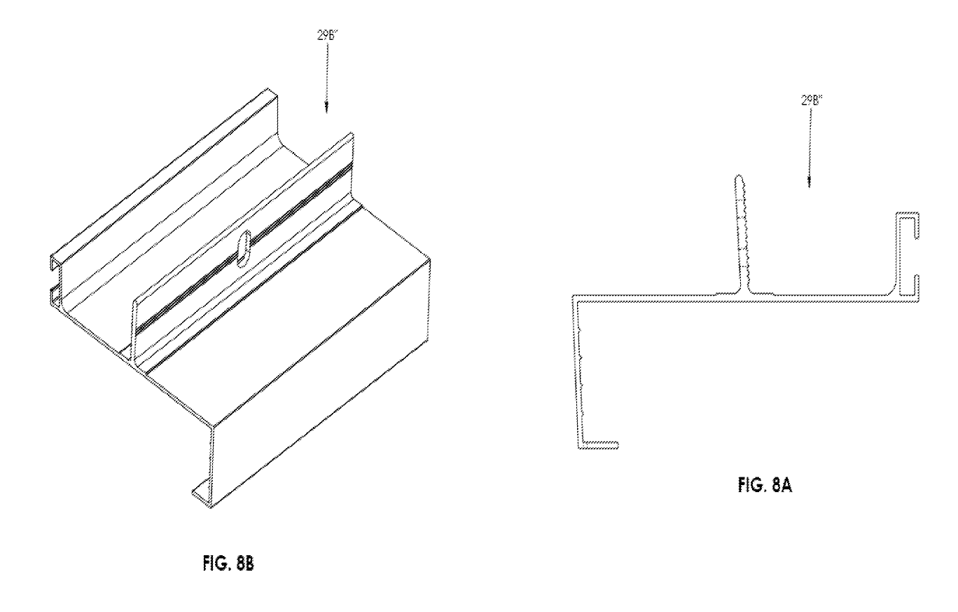

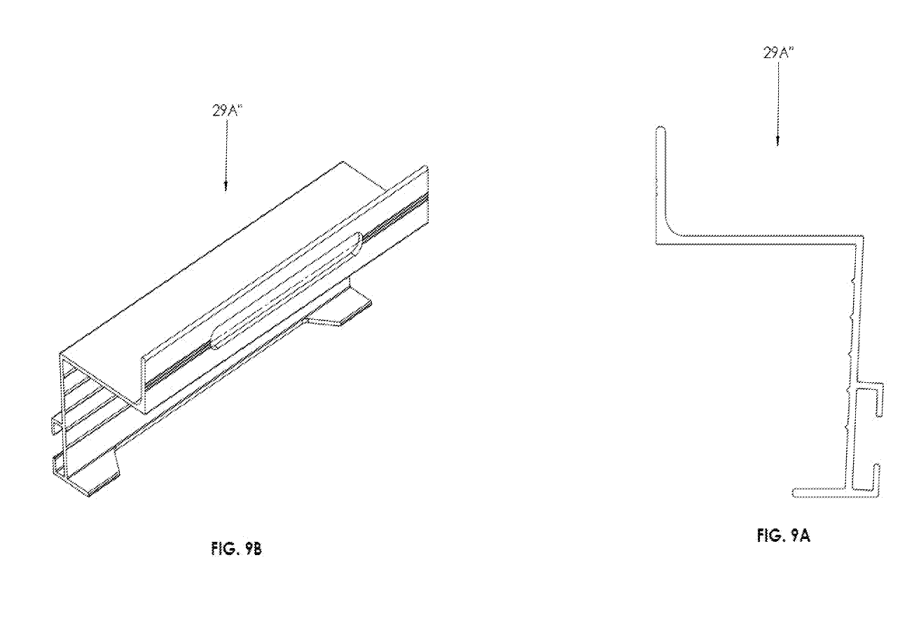

FIGS. 8A, 9A shows a further variation 29B″, 29A″ of the structures of FIGS. 3-4 wherein the channel is omitted and a ridge 41 is provided, to which the foot can be secured (not shown).

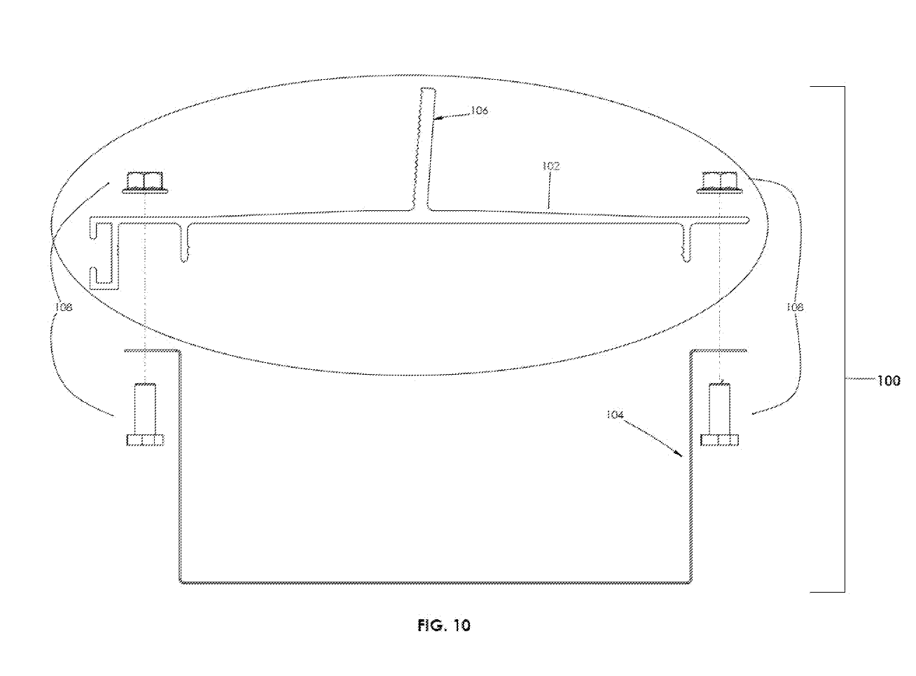

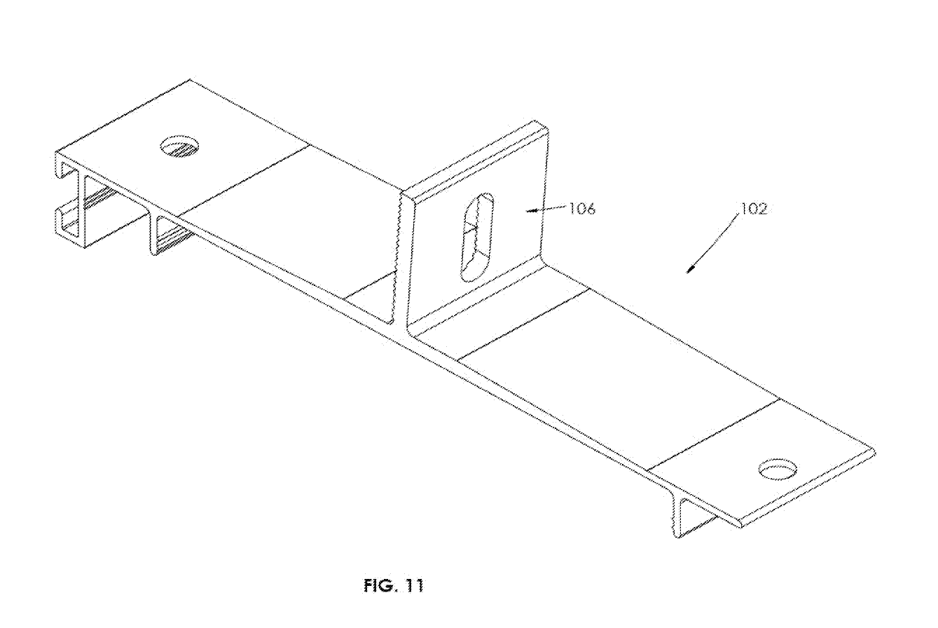

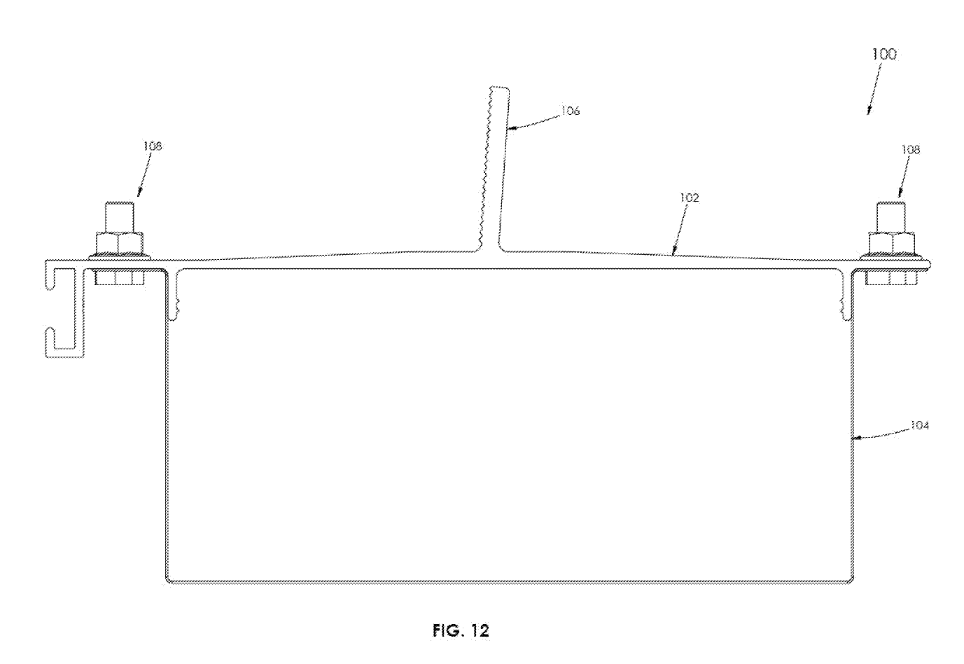

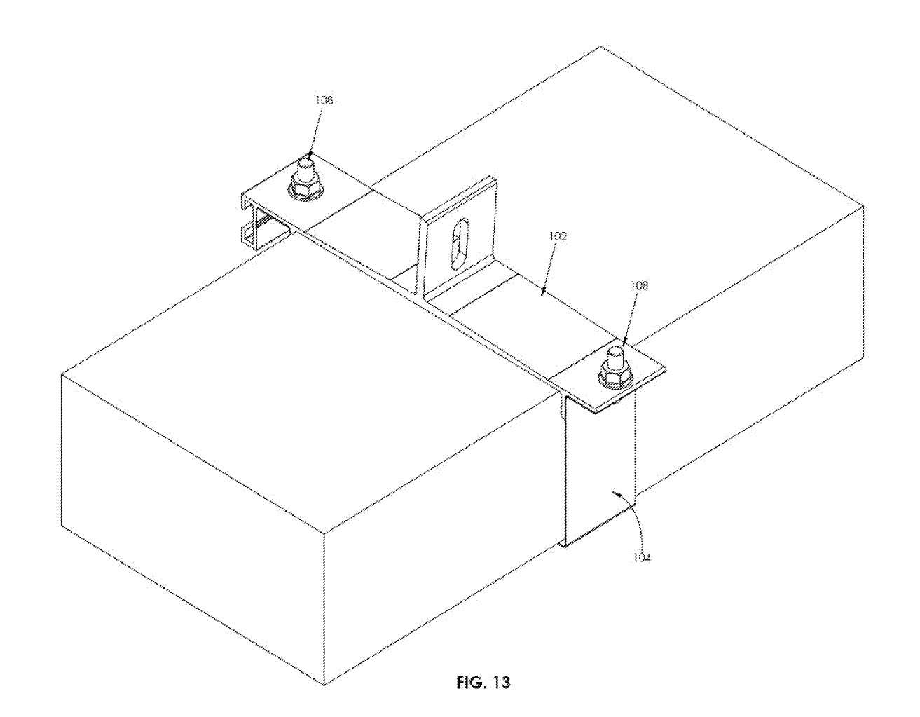

Yet another embodiment is shown in FIGS. 10-13. In this embodiment, the apparatus 100 is defined by a plurality of metal components 102,104, at least one 102 of the components defining a lug 106; and at least one threaded connector 108. This apparatus 100 is shown assembled for in FIG. 12, wherein it will be seen that the at least one threaded connecter 108 connects the plurality of metal components 102,104 together, and is shown in use in FIG. 13, wherein the components 102,104 grip the block.

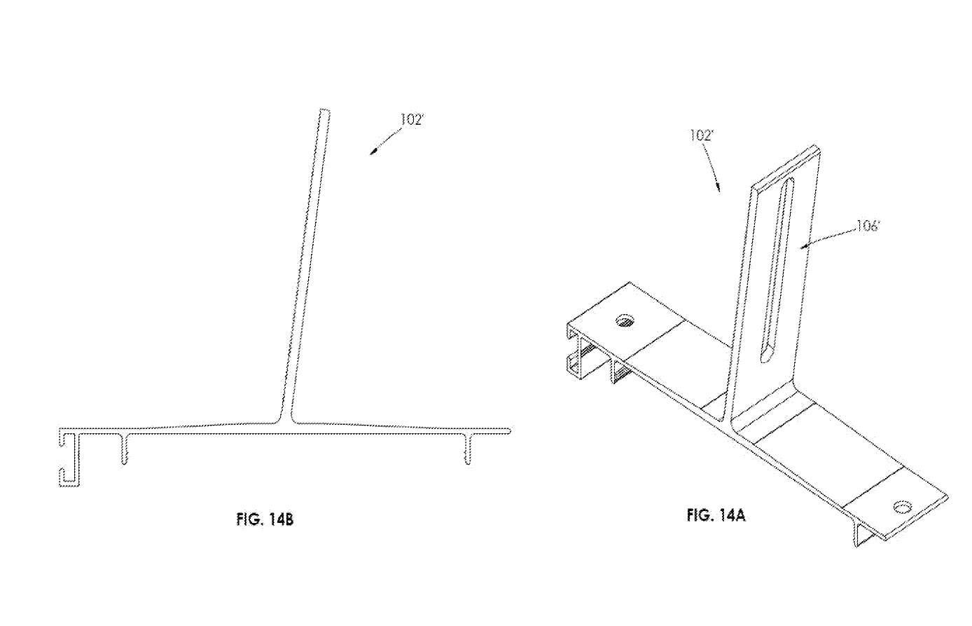

A variant of the structure 102 of FIG. 11 is shown in FIG. 14A and FIG. 14B as 102′; this structure 102′ functions similarly to structure 102 but has a relatively larger lug 106′.

Yet further, example, whereas in the exemplary embodiment of FIGS. 1-6C, it will be seen that the one of the first side surfaces and the one of the second side surfaces can form part of the same side wall, that is, the fingers are drawn towards one another and engage the central web, this is not essential. Fingers could, for example, be urged apart from one another, to engage opposed walls of, for example, adjacent side walls; in this event, the one of the first side surfaces forms part of a side wall that is different from the side wall of which the one of the second side surfaces forms part.

Additionally, whereas in the exemplary embodiment of FIGS. 1-6C, it will be seen that the mechanism can be adapted to permit the hooks to be completely separated from one another, this is not necessary; hinges or other mechanism could potentially be used.

Moreover, the mechanism can be adapted to selectively lock the hooks together throughout a range of positions. Not only does this allow for normal variances associated with manufacture of “the same” block, it permits an apparatus to be used with blocks of differing nominal dimensions.

As well, whereas in the exemplary embodiment of FIGS. 1-6C, each hook has a finger for each core, this is not necessary.

Accordingly, the invention should be understood to be limited only by the accompanying claims, purposively construed.

1. An apparatus for use with a concrete block, the concrete block being of the type having a pair of face shells and a plurality of side walls extending between the face shells, the plurality of side walls including a pair of end shells, each side wall having a first side surface and a second side surface opposed to the first side surface, the face shells and the side walls collectively defining a pair of planar surfaces and one or more cores, each of said one or more cores extending through the block between the pair of planar surfaces, the apparatus comprising:
a pair of hooks, one of the pair of hooks being associated, in use, with one of the planar surfaces and one of the first side surfaces, the other of the pair of hooks associated, in use, with the other of the planar surfaces and one of the second side surfaces, the pair of hooks having a locked configuration wherein the one of the pair of hooks is disposed in abutting relation with the one of the planar surfaces and the one of the first side surfaces and the other of the pair of hooks is disposed in abutting relation with the other of the planar surfaces and the one of the second side surfaces;
a mechanism adapted to selectively lock the pair of hooks in the locked configuration; and
a lug operatively connected to one or more of the pair of the hooks and the mechanism.

2. The apparatus according to claim 1, wherein the one of the first side surfaces and the one of the second side surfaces form part of a single side wall.

3. The apparatus according to claim 1, wherein the one of the first side surfaces forms part of a side wall that is different from the side wall of which the one of the second side surfaces forms part.

4. The apparatus according to claim 1, wherein each hook has a finger for each core.

5. The apparatus according to claim 1, wherein the mechanism is adapted to permit the hooks to be completely separated from one another.

6. The apparatus according to claim 1, wherein the mechanism is adapted to selectively lock the hooks together throughout a range of positions.

7. The apparatus according to claim 1, wherein the mechanism comprises:
a nut and bolt assembly;
for each of the pair of hooks, a part formed integrally therewith, the parts being adapted to be secured together by the nuts and bolt assembly.

8. The apparatus according to claim 7, wherein the parts are formed integrally with the hooks by extrusion, one of the parts has a slot defined therewith adapted to capture the head of the bolt and the other of the parts has an aperture defined therethrough to permit through passage of the threaded shaft of the bolt, the aperture being smaller in dimension than the nut to permit the nut and the bolt head to draw the parts together.

9. An apparatus for use with a concrete block, the apparatus comprising:
a plurality of metal components, at least one of the components defining a lug; and
at least one threaded connector, the at least one threaded connecter connecting the plurality of metal components together in gripping relation to the block in use.
